(19) United States
(12) Patent Application Publication
(10) Pub. No.: US 2025/0126685 A1
(43) Pub. Date: Apr. 17, 2025

(54) AUDIBLE FEEDBACK SYSTEM TO GUIDE POT CENTERING ON A COOKTOP

(71) Applicant: WHIRLPOOL CORPORATION, Benton Harbor, MI (US)

(72) Inventors: Salvatore Baldo, Varese (IT); Mario D. Barbati, Sulmona (IT); Marco Casucci, Varese (IT); Marco Di Caprio, Biandronno (IT); Andrea Gallivanoni, Casorate Semipione (IT)

(73) Assignee: WHIRLPOOL CORPORATION, BENTON HARBOR, MI (US)

(21) Appl. No.: 18/378,762

(22) Filed: Oct. 11, 2023

(51) Int. Cl. H05B 6/06; G08B 3/00; G08B 21/18

(52) U.S. Cl. CPC H05B 6/062; G08B 3/00; G08B 21/182; H05B 2213/05

(57) ABSTRACT

A cooktop includes a burner, a power delivery module including a burner, an actuator for selectively heating the burner, and an audible alert module. The cooktop further includes a control system configured to detect a presence of a cooking vessel with a detection signal from the power delivery module and determine if a location of the cooking vessel is centered on the burner within a first threshold distance. The control system is further configured to, if the location of the cooking vessel is not centered within the first threshold distance, prevent the actuator from selectively heating the burner and generate a first audible alert with the audible alert module.

### BACKGROUND OF THE DISCLOSURE

The present disclosure generally relates to a cooktop with an audible feedback system, and more specifically, to an audible feedback system that guides a user in centering a cooking vessel on a cooktop.

### SUMMARY OF THE DISCLOSURE

According to one aspect of the present disclosure, a cooktop includes a power delivery module including a burner, an actuator for selectively heating the burner via the power delivery module, and an audible alert module. The cooktop further includes a control system configured to detect a presence of a cooking vessel with a detection signal from the power delivery module and determine if a location of the cooking vessel is centered on the burner within a first threshold distance. The control system is further configured to, if the location of the cooking vessel is not centered within the first threshold distance, prevent the actuator from selectively heating the burner and generate a first audible alert with the audible alert module.

According to another aspect of the present disclosure, a cooktop includes a power delivery module including a burner and an audible alert module. The cooktop further includes a control system configured to detect a presence of a cooking vessel with a detection signal that includes at least one of a characteristic of an electro-magnetic field or an ionization current and determine a proximity of the cooking vessel from a position centered on the burner. The control system is further configured to compare the proximity of the cooking vessel to a plurality of threshold distances, and generate an audible alert that changes based on the plurality of threshold distances as the cooking vessel is moved towards or away from the position centered on the burner.

According to yet another aspect of the present disclosure, a cooktop includes a power delivery module including a burner, an actuator for selectively heating the burner via the power delivery module, and an audible alert module. The cooktop further includes a control system configured to detect a presence of a cooking vessel with a detection signal that includes at least one of a characteristic of an electro-magnetic field or an ionization current. The control system is further configured to determine if a location of the cooking vessel is centered on the burner within a first threshold distance, and, if the location of the cooking vessel is not centered within the first threshold distance, prevent the actuator from selectively heating the burner and generate a first audible alert with the audible alert module.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a cooktop with an audible feedback system, according to one aspect of the present disclosure;

FIG. 2 is a top plan view of a cooktop with an audible feedback system, according to one aspect of the present disclosure;

FIG. 3A is a top plan view of a cooktop with a first audible alert, according to one aspect of the present disclosure;

FIG. 3B is a top plan view of a cooktop with a second audible alert, according to one aspect of the present disclosure;

FIG. 3C is a top plan view of a cooktop with a third audible alert, according to one aspect of the present disclosure;

FIG. 4 is a top schematic view of a cooktop with a heating system, according to one aspect of the present disclosure;

FIG. 5 is a top schematic view of a power delivery module of a first construction for a cooktop with an audible feedback system, according to one aspect of the present disclosure;

FIG. 6 is a top schematic view of a power delivery module of a second construction for a cooktop with an audible feedback system, according to one aspect of the present disclosure;

FIG. 7 is a schematic view of a control system of a cooktop, according to one aspect of the present disclosure; and

FIG. 8 is a method audibly guiding a user to center a cooking vessel on a cooktop, according to one aspect of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to an audible feedback system that guides a user in centering a cooking vessel on a cooktop. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

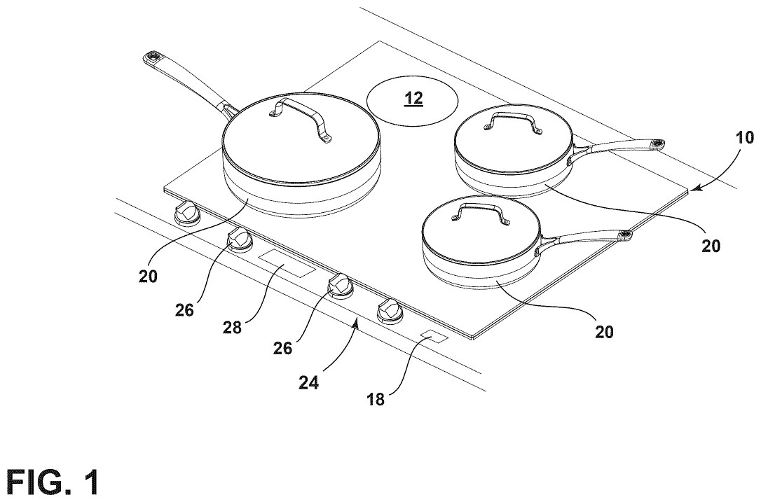

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

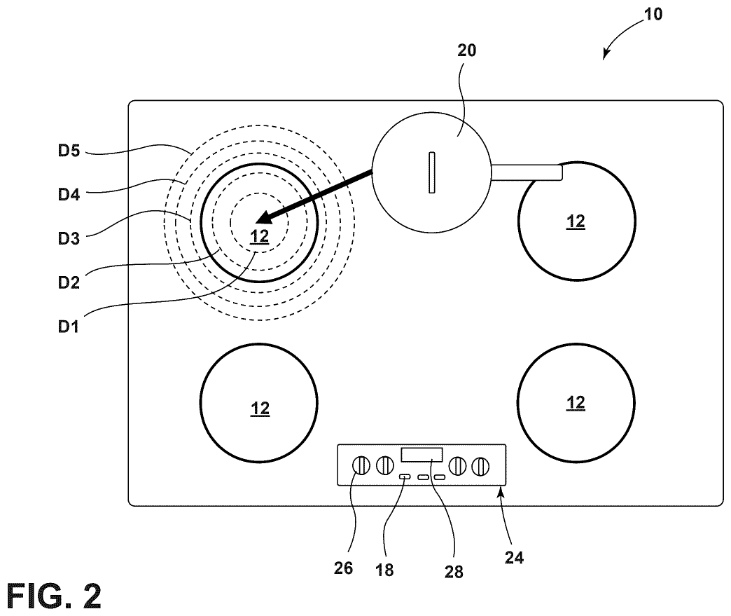

Referring to FIGS. 1-4 and 7, reference numeral 10 generally designates a cooktop. The cooktop 10 includes a burner 12 (e.g., a plurality of burners 12), an actuator 14, a power delivery module 16 that includes the burner 12 and receives instructions from the actuator 14 to heat the burner 12, and an audible alert module 18. The cooktop 10 further includes a control system 100 configured to detect a presence of a cooking vessel 20 with a detection signal from the power delivery module 16 and determine if a location of the cooking vessel 20 is centered on the burner 12 within a first threshold distance D1. The control system 100 is further configured to, if the location of the cooking vessel 20 is not centered within the first threshold distance D1, prevent the actuator 14 from selectively heating the burner 12 and generate a first audible alert with the audible alert module 18.

As best illustrated in FIGS. 1-4, the control system 100 may be further configured to determine if the location (e.g., proximity relative to one of the burners 12) of the cooking vessel 20 is not within a second threshold distance D2. The second threshold distance D2 may be further than the first threshold distance D1. The control system 100 may be configured to generate a second audible alert with the audible alert module 18 that is different than the first audible alert if the location of the cooking vessel 20 is not within the second threshold distance D2. In some embodiments, there may be a plurality of threshold distances D1-D5 that include the first and second threshold distances D1 and D2. As the cooking vessel 20 is aligned with each threshold distance D1-D5, a different audible alert may be generated. In this manner, the audible alerts function as a guide for proper placement of the cooking vessel 20 towards the center of the burner 12. Such an arrangement serves to guide a user to use the cooktop 10 in low visibility conditions (e.g., poor eyesight or low ambient lighting) and to maximize the efficiency of the cooktop 10 (e.g., by only allowing the burner 12 to heat once the cooking vessel 20 is centered thereon). As will be appreciated with further reading, in some embodiments, the detection signal from the power delivery module 16 may not be configured to measure an actual distance or location of the cooking vessel 20, but rather a characteristic (e.g., of the burner 12) that can be translated into location and/or proximity. In this manner, it should be appreciated that by determining the location of the cooking vessel 20 with the detection signal, the detected location of the cooking vessel 20 may refer to an actual location of the cooking vessel 20 in two-dimensional or three-dimensional space, a relative distance between the cooking vessel 20 and one of the burners 12, and/or an extrapolated relative distance between the cooking vessel 20 and the burner 12 based on the characteristic of the burner 12.

With continued reference to FIGS. 1-4, the plurality of threshold distances D1-D5 are illustrated as a series of discrete distances or steps, however, it should be appreciated that the detection signal may be utilized to determine the distance between the cooking vessel 20 and the centered position along a constant gradient. In this manner, the audible alert may continually change as the cooking vessel 20 is moved with essentially an infinite number of threshold distances D1-DN.

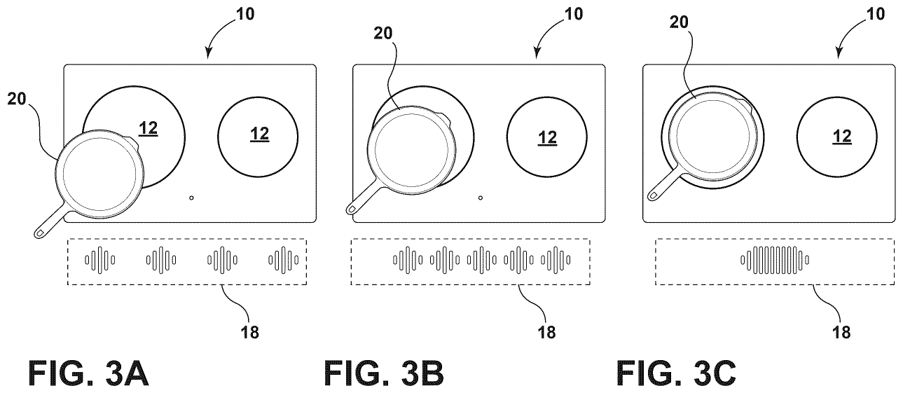

With reference now to FIGS. 3A-3C, in some embodiments, the audible alert may be a series of pulses. For example, the audible alert may be a series of pulses at a first frequency and the second audible alert includes a series of pulses at a second frequency that is greater or less than the first frequency. In some embodiments, the first frequency is greater than the second frequency. In this manner, as the cooking vessel 20 approaches the centered position, the frequency may increase relative to the number of threshold distances D1-D5. Alternatively, the first frequency may be less than the second frequency. In this manner, as the cooking vessel 20 approaches the centered position, the frequency may decrease relative to the number of threshold distances D1-D5.

With continued reference to FIGS. 3A-3C, the audible alert may be other types of sounds. In some embodiments, the audible alert may be based on volume rather than or in addition to frequency. For example, the first audible alert includes a first volume and the second audible alert includes a second volume that is greater or less than the first volume. In some embodiments, the first volume is greater than the second volume. In this manner, as the cooking vessel 20 approaches the centered position, the volume may increase relative to the number of threshold distances D1-D5. Alternatively, the first volume may be less than the second volume. In this manner, as the cooking vessel 20 approaches the centered position, the volume may decrease relative to the number of threshold distances D1-D5. In some embodiments, the audible alert may include a voice that guides the user with directional vocabulary. For example, the voice may guide a user to move the cooking vessel 20 in a forward-backward or a left-right direction relative to the burner 12. In still other embodiments, the audible alert may be identifiable by two or more characteristics. For example, the audible alert may include a frequency associated with movement in the left-right direction and a volume associated with the forward-backward direction. In another example, the audible alert may include a frequency associated with movement in the forward-backward direction and a volume associated with the left-right direction.

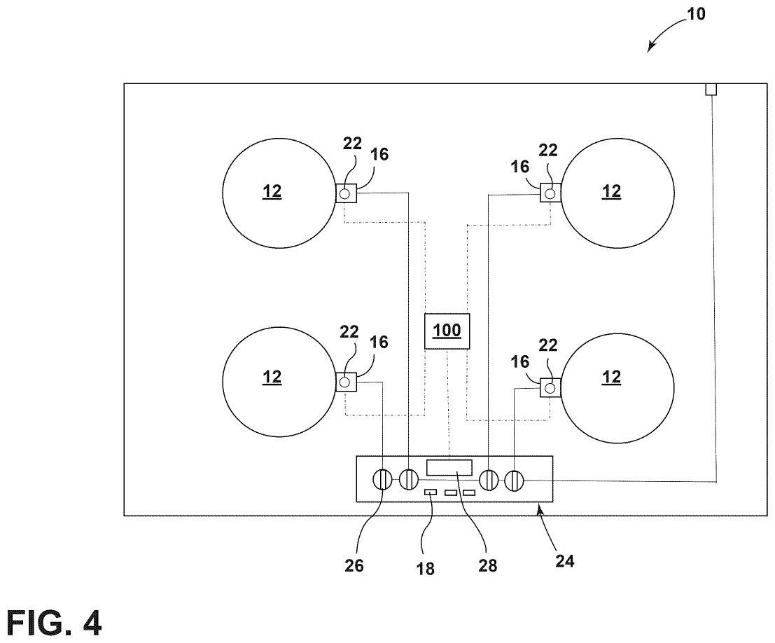

With reference to FIG. 4, the control system 100 may be configured to direct the user to place the cooking vessel 20 on one of the plurality of burners 12 that is closest to the cooking vessel 20. More particularly, each burner 12 may be coupled to the power delivery module 16 and/or the power delivery module 16 may include a plurality of power delivery modules 16 with each power delivery module 16 associated with a different one of the burners 12. In this manner, as the user places the cooking vessel 20 anywhere on the cooktop 10, the control system 100 may generate the audible alert with the audible alert module 18 once the at least one threshold distance D1-D5 associated with one of the burners 12 is breached. In this manner, in some embodiments, the threshold distance D1-D5 associated with one of the burners 12 may not overlap the threshold distance D1-D5 associated with the other burners 12. Each power delivery module 16 may be configured to change a power level in order to generate different levels of heat in an associated burner 12.

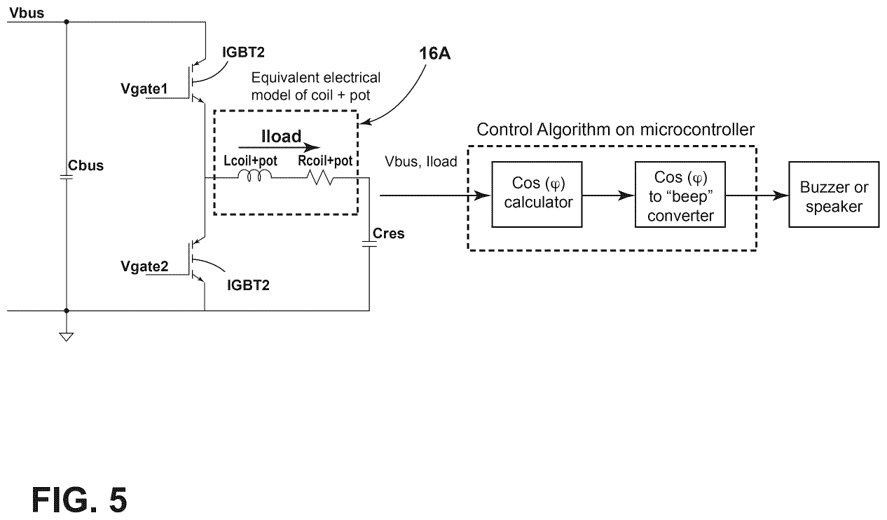

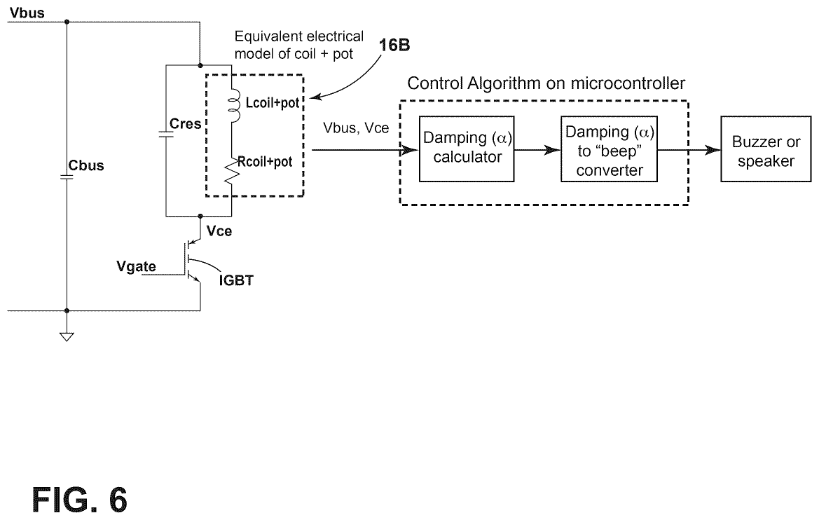

With continued reference to FIG. 4, the burners 12 may be configured as induction burners 12 or, alternatively, gas burners 12. When the burners 12 are configured as induction burner 12, the detection signal includes a characteristic of an electro-magnetic field that may be received by the control system 100 directly from the power delivery module 16 as will be explained in reference to FIGS. 5 and 6. When the burners 12 are configured as gas burners 12, the detection signal includes a characteristic of an ionization current that may be received by the control system 100 a detector 22. More particularly, the detector 22 may be configured as an ionization sensor. In use, the detector 22 is configured to detect changes in the ionization current as a result of the size of a flame and also as a result of a change to the shape of the flame. Therefore, as a cooking vessel 20 is placed on the gas burner 12 and moved along threshold distances D1-D5, the ionization current changes. In this manner, the control system 100 may be configured to determine if the cooking vessel 20 is centered on or offset from the gas burner 12 based on predictive models of the ionization current.

With continued reference to FIG. 4, the cooktop 10 may include a user interface 24 that may include the actuator 14 (e.g., buttons/knobs 26) and a visual display 28. In some embodiments, the audible alert module 18 may be located proximate the user interface 24. In some embodiments, the user interface 24 may be utilized to remove the guiding functionality of the audible alert module 18, change characteristics of the audible alert module 18 (e.g., sound-type, volume, frequency, etc.), and/or the like.

With reference to FIG. 5, the power delivery module 16A is illustrated according to a first construction. More particularly, the power delivery module 16A may not be configured to measure an actual distance, but rather a characteristic (e.g., of the burner 12) that can be translated into location and distance (e.g., by the control system 100). For example, the cooktop 10 may include an induction heating system 30 with half bridge resonant technology. In other examples, the cooktop 10 may include an induction heating system 30 with full bridge resonant technology. An electrical equivalent model of a load detected by the power delivery module 16A as the burner characteristic is an RLC resonant network, where a capacitor Cres is fixed, while the values of Rcoil+pot and Lcoil+pot depend on the proximity of the cooking vessel 20. More particularly, when the burner 12 (e.g., a coil) is barely covered by the cooking vessel 20, the Rcoil+pot value is low and sequentially increases as the cooking vessel 20 becomes in closer proximity and aligned with the burner 12. In the RLC network, a ϕ phase angle between voltage and current can be defined by the power delivery module 16A and/or control system 100. Based on the ϕ phase angle, a cosine of the ϕ phase angle can be calculated (e.g., by the control system 100). Generally, the cosine of the ϕ phase angle (“cos(ϕ)”) can go from 0 to 1. Low values of cos(ϕ) indicate that the load is inductive, and therefore the contribution of the resistance by the presence of the cooking vessel 20 is low (i.e., the burner 12 is only slightly covered by the cooking vessel 20 (e.g., threshold distances D3-D5). On the other hand, high values of cos(ϕ) that approach 1, indicate that the load is resistive, and therefore the contribution of the resistance by the presence of the cooking vessel 20 is high (e.g., threshold distances D1-D2) until it reaches a maximum value (i.e., central alignment). In this manner, by receiving the cos(ϕ) value from the power delivery module 16A and corresponding the cos(ϕ) value to settings of the audible alert module 18 (e.g., sound-type, volume, frequency, etc.) a user may be guided to center the cooking vessel 20 on an associated burner 12. In one implementation, the control system 100 generates a signal to electrically stimulate the burner 12 (e.g., via the actuator 14) with a sequenced pattern of, for example, every 0.5 seconds. For each stimulus, the ϕ phase angle may be detected by the power delivery module 16A and the calculation of cos(ϕ) may be extrapolated by the control system 100 and linked to settings of the audible alert module 18 (e.g., sound-type, volume, frequency, etc.) that will change based on the proximity of the cooking vessel 20 relative to the associated burner 12.

With reference now to FIG. 6, a power delivery module 16B is illustrated according to a second construction. More particularly, the power delivery module 16B may not be configured to measure an actual distance, but rather a characteristic (e.g., of the burner 12) that can be translated into location and distance (e.g., by the control system 100). For example, the cooktop 10 may include an induction heating system 30 with a quasi-resonant technology. An electrical equivalent model of the load is a series RL network, with a fixed capacitor Cres in a parallel configuration. Similar to the power delivery module 16A of the first construction, when the burner 12 (e.g., coil) is slightly covered by the cooking vessel 20, the Rcoil+pot value is low and increases until it becomes a maximum value when the cooking vessel 20 becomes perfectly centered on the burner 12. In the electrical network, a damping value α can be detected by the power delivery module 16B, which is proportional to the Rcoil+pot value. In this manner, low damping values α indicate that the load is inductive, and therefore the contribution of the resistance by the presence of the cooking vessel 20 is low (e.g., threshold distances D3-D5). High damping values α, on the other hand, indicate that the load is resistive, and therefore the contribution of the resistance by the presence of the cooking vessel 20 is high (e.g., threshold distances D1-D2) and increases to a maximum value when the cooking vessel 20 is centered on the burner 12. In one implementation, the control system 100 generates a signal to electrically stimulate the burner 12 (e.g., via the actuator 14) with a sequenced pattern of, for example, 0.5 seconds. For each stimulus, the calculation of the damping value α can be determined by the power delivery module 16B or the control system 100 and linked to settings of the audible alert module 18 (e.g., sound-type, volume, frequency, etc.) that will change based on the proximity of the cooking vessel 20 relative to the associated burner 12.

With reference to FIGS. 5 and 6, the power delivery module 16 may include other configurations and constructions. For example, the power delivery module 16 may include detector coils, such as those included in commonly-assigned U.S. Patent Application Publication No. 2023/0209665, titled “Cooking Article Detection System With Differential Detection Coils,” which is incorporated by reference in its entirety. More particularly, the detectors are formed by several small inductors, printed in a flex printed circuit board and placed between a power coil (or a radiant element) and a glass top. The detectors are powered with a high frequency signal with high resolution for the detection of a position and shape of a cooking vessel. Similar to the power delivery modules 16A and 16B, the high frequency signal can be linked to settings of the audible alert module 18 (e.g., sound-type, volume, frequency, etc.) that will change based on the proximity of the cooking vessel relative to the associated burner coil or radiant element (e.g., burner). Moreover, other types of detectors may be utilized including vision systems, object detection, and/or the like.

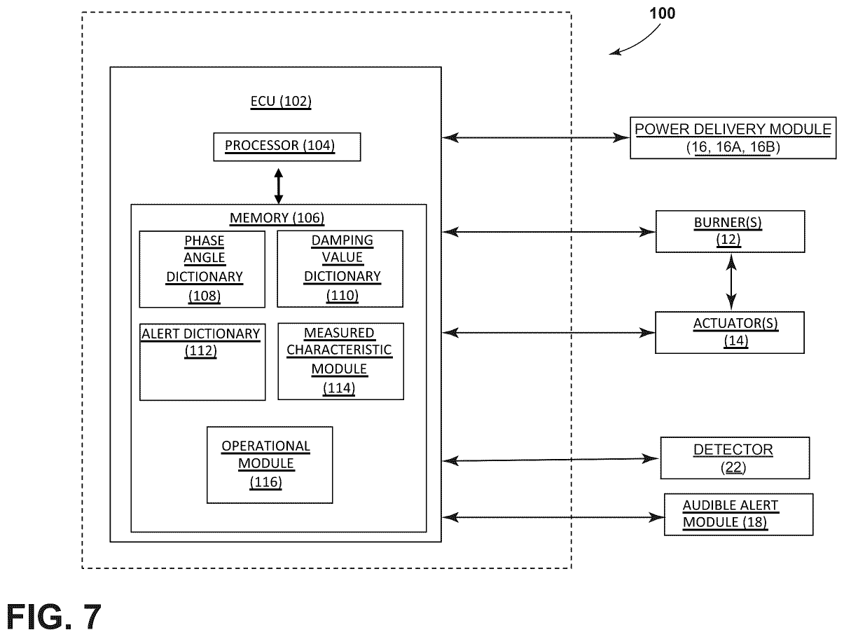

With reference now to FIG. 7, the control system 100 may include at least one electronic control unit (ECU) 102. The at least one ECU 102 may be located in the cooktop 10. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the cooktop 10. The actuator 14, the power delivery module 16, 16A, 16B, the audible alert module 18, the detector 22 (i.e., when the burners 12 are configured as gas burners 12), and the user interface 24 may, therefore, be controlled by, receive from, or transmit signals to the control system 100. The memory 106 may, therefore, include a phase angle dictionary 108, damping value dictionary 110, an alert dictionary 112, a measured characteristic module 114, and an operational module 116. The phase angle dictionary 108 may include instructions to compare measurements from the power delivery module 16A related to the ϕ phase angle and calculate a cosine of the ϕ phase angle. The value of the cos(ϕ) may then be associated with one or more instructions to the audible alert module 18 (e.g., sound-type, volume, frequency, etc.). The damping value dictionary 110 may include instructions to compare measurements from the power delivery module 16B related to the damping value α and calculate the damping value α. The damping value α may then be associated with one or more instructions to the audible alert module 18 (e.g., sound-type, volume, frequency, etc.). The alert dictionary 112 may include instructions related to the settings of the alert module 18 (e.g., sound-type, volume, frequency, etc.), which may be changed, for example, by the user interface 24. The measured characteristic module 114 may include measurements from the power delivery module 16, 16A, 16B related to values associated with the proximity of the cooking vessel 20 relative to the associated burner 12. The operational module 116 may include instructions such as periodic stimulation of the burner 12 (e.g., every 0.5 seconds) via the power delivery module 16.

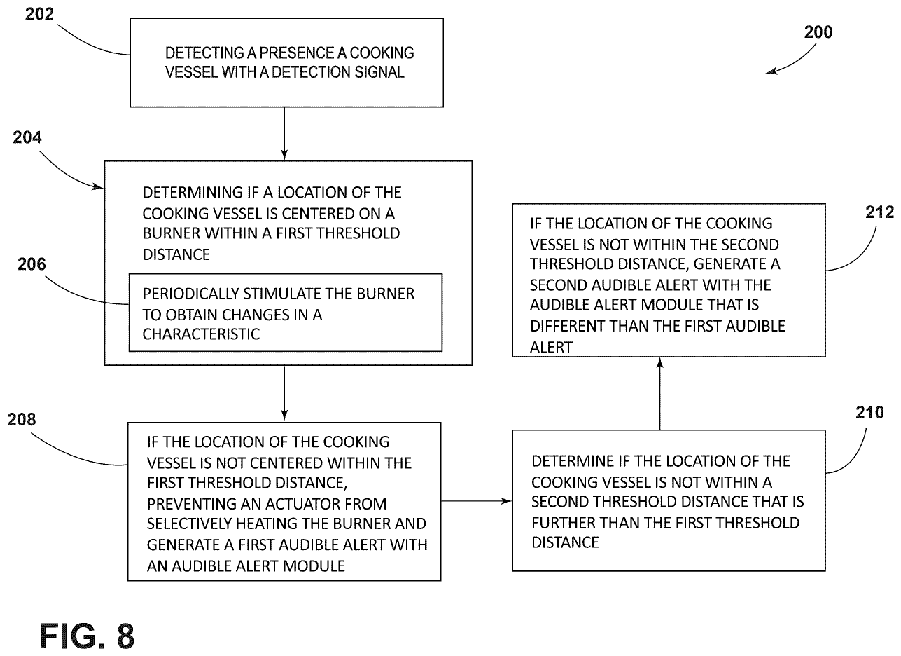

With reference now to FIG. 8, a method 200 of guiding a user to place a cooking vessel 20 on a burner 12 of a cooktop 10 is illustrated. At step 202 the method includes detecting a presence the cooking vessel 20 with the power delivery module 16, 16A, 16B. For example, the power delivery module 16, 16A, 16B may be configured to measure a characteristic (e.g., cos(ϕ), damping value α, and or the like) of the burner 12.

The method 200 may further include, at step 204, determining if a location of the cooking vessel 20 is centered on the burner 12 within a first threshold distance (e.g., D1-D5). For example, the power delivery module 16, 16A, 16B may measure changes in the characteristic (e.g., cos(ϕ), damping value α, and or the like) of the burner 12. Step 204 may include, at step 206, periodically stimulating the burner 12 to obtain changes in the characteristic.

The method 200 may further include, at step 208, if the location of the cooking vessel 20 is not centered within the first threshold distance D1, preventing the actuator 14 and/or power delivery module 16 from selectively heating the burner 12 and generating a first audible alert with an audible alert module 18. More particularly, the control system 100 may be configured to generate a signal to audible alert module 18 to generate the first audible alert with a volume, tone, frequency, or vocal instruction.

The method 200 may further include, at step 210, determining if the location (e.g., proximity relative to one of the burners 12) of the cooking vessel 20 is not within a second threshold distance D2. For example, the second threshold distance D2 may be further than the first threshold distance D1. The method 200 may further include, at step 212, if the location of the cooking vessel is not within the second threshold distance, generating a second audible alert with the audible alert module that is different than the first audible alert. For example, the control system 100 may be configured to generate a second audible alert with the audible alert module 18 that is different than the first audible alert if the location of the cooking vessel 20 is not within the second threshold distance D2. More particularly, the second audible alert may include a difference in volume, tone, frequency, or vocal instruction.

The embodiments disclosed herein may be further summarized in the following paragraphs and further characterized by combinations of any and all of the various aspects described therein.

According to one aspect of the present disclosure, a cooktop includes a power delivery module including a burner, an actuator for selectively heating the burner via the power delivery module, and an audible alert module. The cooktop further includes a control system configured to detect a presence of a cooking vessel with a detection signal from the power delivery module and determine if a location of the cooking vessel is centered on the burner within a first threshold distance. The control system is further configured to, if the location of the cooking vessel is not centered within the first threshold distance, prevent the actuator from selectively heating the burner and generate a first audible alert with the audible alert module.

According to another aspect, the control system is further configured to determine if the location of the cooking vessel is not within a second threshold distance that is further than the first threshold distance, and, if the location of the cooking vessel is not within the second threshold distance, generate a second audible alert with the audible alert module that is different than the first audible alert.

According to yet another aspect, the first audible alert includes a series of pulses at a first frequency and the second audible alert includes a series of pulses at a second frequency that is greater or less than the first frequency.

According to still yet another aspect, the first frequency is greater than the second frequency.

According to another aspect, the first audible alert includes a first volume and the second audible alert includes a second volume that is greater or less than the first volume.

According to yet another aspect, the first volume is greater than the second volume.

According to still yet another aspect, the first audible alert includes a voice that guides the user with directional vocabulary.

According to another aspect, the burner is configured as an induction burner that generates an electro-magnetic field and detection signal includes a characteristic of the electro-magnetic field.

According to yet another aspect, the burner is configured as an induction burner with a power-delivery induction coil and at least one detector coil.

According to still yet another aspect, the burner is configured as an induction burner and the control system is configured to electrically stimulate the burner in a sequenced pattern and the power delivery system transmits the detection signal every time the burner is electrically stimulated.

According to another aspect of the present disclosure, a cooktop includes a power delivery module including a burner and an audible alert module. The cooktop further includes a control system configured to detect a presence of a cooking vessel with a detection signal that includes at least one of a characteristic of an electro-magnetic field or an ionization current and determine a proximity of the cooking vessel from a position centered on the burner. The control system is further configured to compare the proximity of the cooking vessel to a plurality of threshold distances, and generate an audible alert that changes based on the plurality of threshold distances as the cooking vessel is moved towards or away from the position centered on the burner.

According to another aspect, the detection signal includes a characteristic of an electro-magnetic field received from the power delivery module or a characteristic of a ionization current received from a ionization sensor.

According to yet another aspect, the audible alert includes a series of pulses at a frequency that increases or decreases when the cooking vessel is moved towards the position centered on the burner.

According to still yet another aspect, the frequency is greater as the cooking vessel approaches the position centered on the burner.

According to another aspect, the audible alert includes a volume that increases or decreases when the cooking vessel is moved towards the position centered on the burner.

According to yet another aspect, the audible alert includes a volume that increases or decreases when the cooking vessel is moved towards the position centered on the burner.

According to still yet another aspect, the audible alert includes a voice that guides the user with directional vocabulary.

According to another aspect, the cooktop includes an actuator for selectively heating the burner and the control system is further configured to prevent the actuator from heating the burner if the cooking vessel is outside of at least one of the plurality of threshold distances.

According to yet another aspect of the present disclosure, a cooktop includes a power delivery module including a burner, an actuator for selectively heating the burner via the power delivery module, and an audible alert module. The cooktop further includes a control system configured to detect a presence of a cooking vessel with a detection signal that includes at least one of a characteristic of an electro-magnetic field or an ionization current. The control system is further configured to determine if a location of the cooking vessel is centered on the burner within a first threshold distance, and, if the location of the cooking vessel is not centered within the first threshold distance, prevent the actuator from selectively heating the burner and generate a first audible alert with the audible alert module.

According to another aspect, the control system is further configured to determine if the location of the cooking vessel is not within a second threshold distance that is further than the first threshold distance, and, if the location of the cooking vessel is not within the second threshold distance, generate a second audible alert with the audible alert module that is different than the first audible alert.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooktop comprising:
a power delivery module including a burner;
an actuator for selectively heating the burner via the power delivery module;
an audible alert module; and
a control system configured to:
detect a presence a cooking vessel with a detection signal from the power delivery module;
determine if a location of the cooking vessel is centered on the burner within a first threshold distance; and
if the location of the cooking vessel is not centered within the first threshold distance, prevent the actuator from selectively heating the burner and generate a first audible alert with the audible alert module.

2. The cooktop of claim 1, wherein the control system is further configured to:
determine if the location of the cooking vessel is not within a second threshold distance that is further than the first threshold distance; and
if the location of the cooking vessel is not within the second threshold distance, generate a second audible alert with the audible alert module that is different than the first audible alert.

3. The cooktop of claim 2, wherein the first audible alert includes a series of pulses at a first frequency and the second audible alert includes a series of pulses at a second frequency that is greater or less than the first frequency.

4. The cooktop of claim 3, wherein the first frequency is greater than the second frequency.

5. The cooktop of claim 2, wherein the first audible alert includes a first volume and the second audible alert includes a second volume that is greater or less than the first volume.

6. The cooktop of claim 5, wherein the first volume is greater than the second volume.

7. The cooktop of claim 1, wherein the first audible alert includes a voice that guides a user with directional vocabulary.

8. The cooktop of claim 1, wherein the burner is configured as an induction burner that generates an electro-magnetic field and the detection signal includes a characteristic of the electro-magnetic field.

9. The cooktop of claim 1, wherein the burner is configured as an induction burner with a power-delivery induction coil and at least one detector coil.

10. The cooktop of claim 1, wherein the burner is configured as an induction burner and the control system is configured to electrically stimulate the burner in a sequenced pattern and the power delivery system transmits the detection signal every time the burner is electrically stimulated.

11. A cooktop comprising:
a power delivery module including a burner;
an audible alert module; and
a control system configured to:
detect a presence of a cooking vessel with a detection signal that includes at least one of a characteristic of an electro-magnetic field or an ionization current;
determine a proximity of the cooking vessel from a position centered on the burner;
compare the proximity of the cooking vessel to a plurality of threshold distances; and
generate an audible alert that changes based on the plurality of threshold distances as the cooking vessel is moved towards or away from the position centered on the burner.

12. The cooktop of claim 11, wherein the detection signal includes a characteristic of an electro-magnetic field received from the power delivery module or a characteristic of a ionization current received from a ionization sensor.

13. The cooktop of claim 11, wherein the audible alert includes a series of pulses at a frequency that increases or decreases when the cooking vessel is moved towards the position centered on the burner.

14. The cooktop of claim 13, wherein the frequency is greater as the cooking vessel approaches the position centered on the burner.

15. The cooktop of claim 11, wherein the audible alert includes a volume that increases or decreases when the cooking vessel is moved towards the position centered on the burner.

16. The cooktop of claim 11, wherein the audible alert includes a volume that increases or decreases when the cooking vessel is moved towards the position centered on the burner.

17. The cooktop of claim 11, wherein the audible alert includes a voice that guides a user with directional vocabulary.

18. The cooktop of claim 11, further including an actuator for selectively heating the burner and wherein the control system is further configured to prevent the actuator from heating the burner if the cooking vessel is outside of at least one of the plurality of threshold distances.

19. A cooktop comprising:
a power delivery module including a burner;
an actuator for selectively heating the burner via the power delivery module;
an audible alert module; and
a control system configured to:
detect a presence of a cooking vessel with a detection signal that includes at least one of a characteristic of an electro-magnetic field or an ionization current;
determine if a location of the cooking vessel is centered on the burner within a first threshold distance; and
if the location of the cooking vessel is not centered within the first threshold distance, prevent the actuator from selectively heating the burner and generate a first audible alert with the audible alert module.

20. The cooktop of claim 19, wherein the control system is further configured to:
determine if the location of the cooking vessel is not within a second threshold distance that is further than the first threshold distance; and
if the location of the cooking vessel is not within the second threshold distance, generate a second audible alert with the audible alert module that is different than the first audible alert.
